(19) United States
(12) Patent Application Publication
(10) Pub. No.: US 2024/0214825 A1
(43) Pub. Date: Jun. 27, 2024

(54) PCI Allocation Using Dynamic Region Locking

(71) Applicant: Parallel Wireless, Inc., Nashua, NH (US)

(72) Inventors: Vikram Karandikar, Nashua, NH (US); Rohit Saini, Pune (IN); Rajesh Vaidya, Pune (IN)

(21) Appl. No.: 18/525,846

(22) Filed: Nov. 30, 2023

Related U.S. Application Data
(60) Provisional application No. 63/385,476, filed on Nov. 30, 2022.

(51) Int. Cl. H04W 16/10; H04W 8/26; H04W 16/18; H04W 24/02

(52) U.S. Cl. CPC H04W 16/10; H04W 16/18; H04W 24/02; H04W 8/26

(57) ABSTRACT

The invention of this PCI Allocation using Dynamic Region Locking is mainly from system perspective how to allocate a conflict-free PCI in a dynamic environment without locking the entire devices. This achieves significant parallelism in PCI allocation and still achieve non-conflicting PCI allocation.

### CROSS-REFERENCE TO RELATED APPLICATIONS

The present application claims priority under 35 U.S.C. § 119(e) to U.S. Provisional Pat. App. No. 63/385,476, which is hereby incorporated by reference in its entirety for all purposes.

This application also hereby incorporates by reference, for all purposes, each of the following U.S. Patent Application Publications in their entirety: U.S. Pat. No. 20170013513A1; U.S. Pat. No. 20170026845A1; U.S. Pat. No. 20170055186A1; U.S. Pat. No. 20170070436A1; U.S. Pat. No. 20170077979A1; U.S. Pat. No. 20170019375A1; U.S. Pat. No. 20170111482A1; U.S. Pat. No. 20170048710A1; U.S. Pat. No. 20170127409A1; U.S. Pat. No. 20170064621A1; U.S. Pat. No. 20170202006A1; U.S. Pat. No. 20170238278A1; U.S. Pat. No. 20170171828A1; U.S. Pat. No. 20170181119A1; U.S. Pat. No. 20170273134A1; U.S. Pat. No. 20170272330A1; U.S. Pat. No. 20170208560A1; U.S. Pat. No. 20170288813A1; U.S. Pat. No. 20170295510A1; U.S. Pat. No. 20170303163A1; U.S. Pat. No. 20170257133A1; and U.S. Pat. No. 20200128414A1. This application also hereby incorporates by reference U.S. Pat. No. 8,879,416, “Heterogeneous Mesh Network and Multi-RAT Node Used Therein,” filed May 8, 2013; U.S. Pat. No. 9,113,352, “Heterogeneous Self-Organizing Network for Access and Backhaul,” filed Sep. 12, 2013; U.S. Pat. No. 8,867,418, “Methods of Incorporating an Ad Hoc Cellular Network Into a Fixed Cellular Network,” filed Feb. 18, 2014; U.S. patent application Ser. No. 14/034,915, “Dynamic Multi-Access Wireless Network Virtualization,” filed Sep. 24, 2013; U.S. patent application Ser. No. 14/289,821, “Method of Connecting Security Gateway to Mesh Network,” filed May 29, 2014; U.S. patent application Ser. No. 14/500,989, “Adjusting Transmit Power Across a Network,” filed Sep. 29, 2014; U.S. patent application Ser. No. 14/506,587, “Multicast and Broadcast Services Over a Mesh Network,” filed Oct. 3, 2014; U.S. patent application Ser. No. 14/510,074, “Parameter Optimization and Event Prediction Based on Cell Heuristics,” filed Oct. 8, 2014, U.S. patent application Ser. No. 14/642,544, “Federated X2 Gateway,” filed Mar. 9, 2015, and U.S. patent application Ser. No. 14/936,267, “Self-Calibrating and Self-Adjusting Network,” filed Nov. 9, 2015; U.S. patent application Ser. No. 15/607,425, “End-to-End Prioritization for Mobile Base Station,” filed May 26, 2017; U.S. patent application Ser. No. 15/803,737, “Traffic Shaping and End-to-End Prioritization,” filed Nov. 27, 2017, each in its entirety for all purposes, having attorney docket numbers PWS-71700US01, US02, US03, 71710US01, 71721US01, 71729US01, 71730US01, 71731US01, 71756US01, 71775US01, 71865US01, and 71866US01, respectively. This document also hereby incorporates by reference U.S. Pat. Nos. 9,107,092, 8,867,418, and 9,232,547 in their entirety. This document also hereby incorporates by reference U.S. patent application Ser. No. 14/822,839, U.S. patent application Ser. No. 15/828,427, U.S. Pat. App. Pub. Nos. U.S. Pat. No. 20170273134A1, U.S. Pat. No. 20170127409A1, U.S. Pat. No. 20200128414A1, U.S. Pat. No. 20230019380A1 in their entirety. Features and characteristics of and pertaining to the systems and methods described in the present disclosure, including details of the multi-RAT nodes and the gateway described herein, are provided in the documents incorporated by reference.

### BACKGROUND

PCI allocation is a 3GPP procedure. Every Radio Cell is assigned a PCI. The allocation should be non-conflicting with other Radio Cells in the close vicinity. Non-conflicting PCI allocation in as much parallelism as possible is what being achieved through the algorithm proposed in the document.

### SUMMARY

In a first embodiment, a method may be disclosed, comprising: receiving a PCI allocation request may be received from a cell; identifying a dynamic region for the received PCI allocation request; performing a check to determine if other PCI allocation requests may be processing in the dynamic region; processing, if there may be no other requests in the dynamic region, the received PCI allocation request; enqueing, if there may be other requests in the dynamic region, the received PCI allocation request. The check may be performed by: traversing a request data structure (like a queue) and looking for all matches for a given region; looking up the current region to see if that region may be locked using a synchronization mechanism like a lock or a spinlock in a synchronization data structure; searching a queue of requests by using the geographic location. The dynamic region may include a lat/long and a radius. The regions may be made dynamic by adjusting the size of the regions at runtime based on configuration, to improve performance or to reduce load. The method may further comprise separating the request into requests for each region. The method may be performed at a SON, EMS, or near-RT RIC.

### BRIEF DESCRIPTION OF THE DRAWINGS

FIG. 1 is a schematic diagram of regions in a cellular network, in accordance with some embodiments.

FIG. 2 is a flow diagram of messaging for PCI allocation in a cellular network, in accordance with some embodiments.

FIG. 3 is a flowchart of messaging for PCI allocation in a cellular network, in accordance with some embodiments.

FIG. 4 is a further flowchart of messaging for PCI allocation in a cellular network, in accordance with some embodiments.

FIG. 5 is a schematic diagram of a multi-RAT RAN deployment architecture, in accordance with some embodiments.

FIG. 6 is a further schematic diagram of a multi-RAT RAN deployment architecture, in accordance with some embodiments.

FIG. 7 is a schematic diagram showing a microservice logical architecture, in accordance with some embodiments.

FIG. 8 is a schematic diagram showing a microservice logical architecture with front and back-end pods, in accordance with some embodiments.

### DETAILED DESCRIPTION

Current implementation of PCI allocation, in PW SON, works on global lock and sequential allocation. This solution does not scale well as number of deployed Cells increase. Slightly improved version of the PCI allocation algorithm uses static regions.

The new approach for PCI allocation proposes Dynamic Regions for locking and achieving parallelism. Idea is to create the coverage region dynamically based on GEO location of a cell. PCI allocation requests inside such dynamic region are sequentially handled. But multiple such Dynamic Regions can safely continue PCI allocation for the Cells within respective regions. Within one Dynamic Region the PCI allocation uses sequential approach.

Synchronization and parallelism are achieved by dynamically creating coverage regions based on GEO location reported by cell. The cells that are part of the local synchronization region wait for their turn for PCI allocation. The synchronization region also ensures FIFO behavior for PCI allocation.

The present method is able to allocate non conflicting PCI; Achieves parallelism without locking entire pool of devices for synchronization.

Synchronization and parallelism is achieved by dynamically creating local regions based on GEO location reported by Cell. The cells that are part of the local synchronization region wait for their turn for PCI allocation. The synchronization region also ensures FIFO behavior for PCI allocation.

How is it improved over what is well-known? It: Helps create non intersecting synchronization regions dynamically so that PCI allocation can happen simultaneously. Avoids starvation of synchronized Cells by using admission timestamp and avoids huge timeouts on device side. Less bookkeeping required and application can be a multiple replica/multithreaded/ and or distributed. This solution can further be enhanced to support moving cells.

### Scenario 1: Simultaneous PCI Allocation for Two Cells in Same Dynamic Region 1

Here, Cell1 and Cell2 are both in dynamic region 1.

At t0 and t1, Cell1 and Cell2 PCI allocation requests are received respt.

Since they belong to same dynamic region, these requests are handled sequentially and only one of them will be made to proceed with PCI allocation. At T0+ and T1+, both cells come to know there are other cells also which are requesting for PCI allocation.

Cell to proceed first will be decided on the FCFS basis. Here Cell1 is selected at T0+ as winner. In this case, Cell1 proceeds with PCI allocation at T0+2 and a conflict-free PCI is allocated.

As soon as Cell1 PCI allocation is complete, processing of Cell2 PCI allocation request is started.

### Scenario 2: Simultaneous PCI Allocation for Two Cells in Different Dynamic Regions

Here, Cell1 is in dynamic region 1 and Cell4 is in dynamic region 2.

At t0 and t1, Cell1 and Cell4 PCI allocation requests are received respt.

Since both cells are different dynamic regions, so their PCI allocation can proceed in parallel. At T0+ and T1+, Cell1 and Cell4 understands there is no other cell requesting PCI allocation in region 1 and region4. Hence both cells proceed further with PCI allocation.

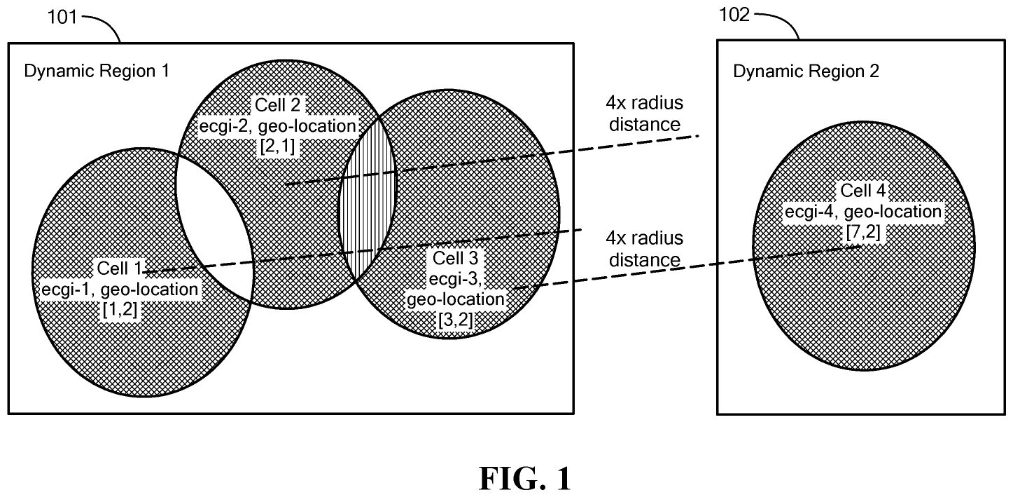

FIG. 1 is a schematic diagram of regions in a cellular network, in accordance with some embodiments. Dynamic region 101 and dynamic region 102 are shown. Dynamic region 101 contains 3 cells, numbered 1, 2, and 3, each with its own ECGI and with geolocation coordinates stored in a database at the EMS management server. The location values may be a latitude and a longitude, or lat/long, GPS coordinates, or other geographic coordinates corresponding with coordinates in real world space. The location values may be manually configured by the network operator, or automatically acquired from the cells using a local GPS antenna, or some combination thereof. As shown, the coverage area for each of the cells have roughly a similar geographic radius, but it is understood that the coverage area will vary based on the specific geography of coverage, e.g., mountains and height and the like. Noteworthy is that region 1 and region 2 are significantly separated, e.g., almost 4× the radius distance of cell 4 as shown.

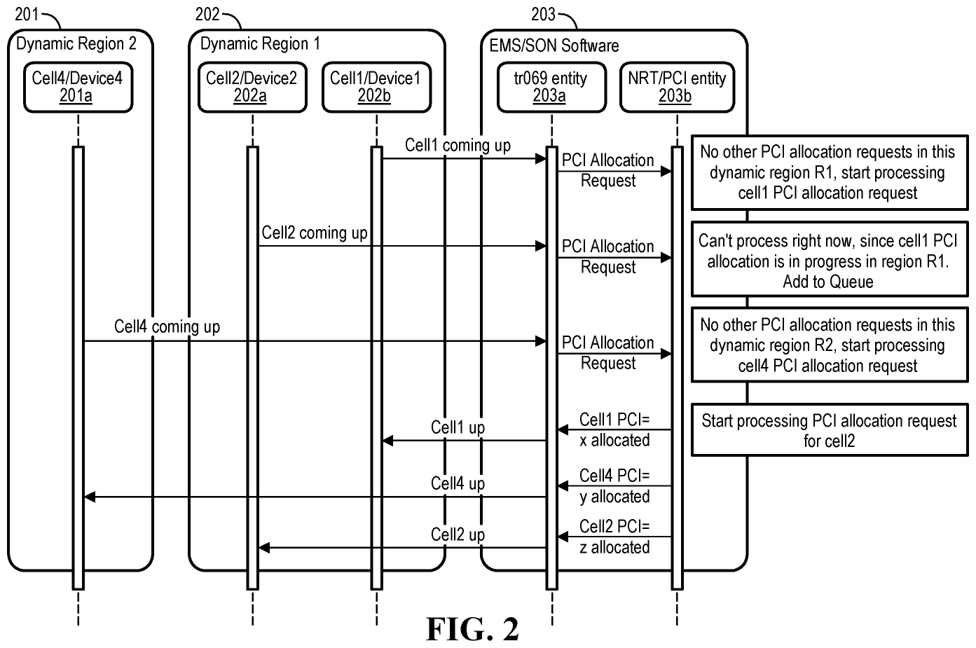

FIG. 2 is a flow diagram of messaging for PCI allocation in a cellular network, in accordance with some embodiments. The cell numbers and regions correspond to the cells schematically illustrated in FIG. 1. In the flow diagram of FIG. 2, a scenario is shown wherein cell 1 202b, then cell 2 202a, then cell 4 201a request a PCI from the EMS/SON software 203 (which comprises a tr069 entity 203a and NRT/PCI entity 203b), in that order. Region locking is used to avoid allocating two PCIs for cells within close geographic proximity, e.g., the cells 202a and 202b in dynamic region 1 202.

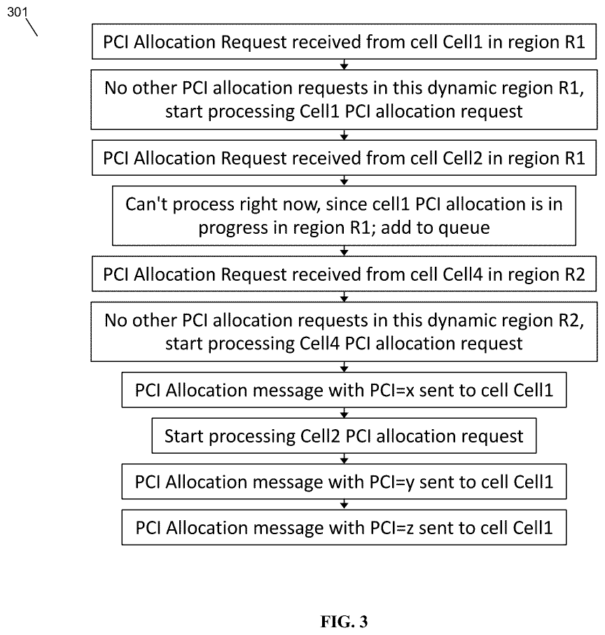

FIG. 3 is a flowchart of messaging for PCI allocation in a cellular network, in accordance with some embodiments. The flowchart corresponds to the order of the steps shown in FIG. 2 and the cells illustrated in FIG. 1. Roughly, a PCI Allocation Request received from cell Cell1 in region R1; since no other PCI allocation requests in this dynamic region R1, the EMS starts processing Cell1 PCI allocation request. Then a PCI Allocation Request received from cell Cell2 in region R1, but the EMS declines to process it, since cell1 PCI allocation is in progress in region R1, and instead adds the request to a queue. Next, PCI Allocation Request is received by the EMS from cell Cell4 in region R2, and since no other PCI allocation requests in this dynamic region R2, it starts processing Cell4 PCI allocation request. Next, the EMS sends a PCI Allocation message with PCI=x sent to cell Cell1, and then since the region is no longer being region-locked, it starts processing Cell2's PCI allocation request. Next, PCI Allocation message with PCI=y sent to cell Cell1 and next, PCI Allocation message with PCI=z sent to cell Cell1.

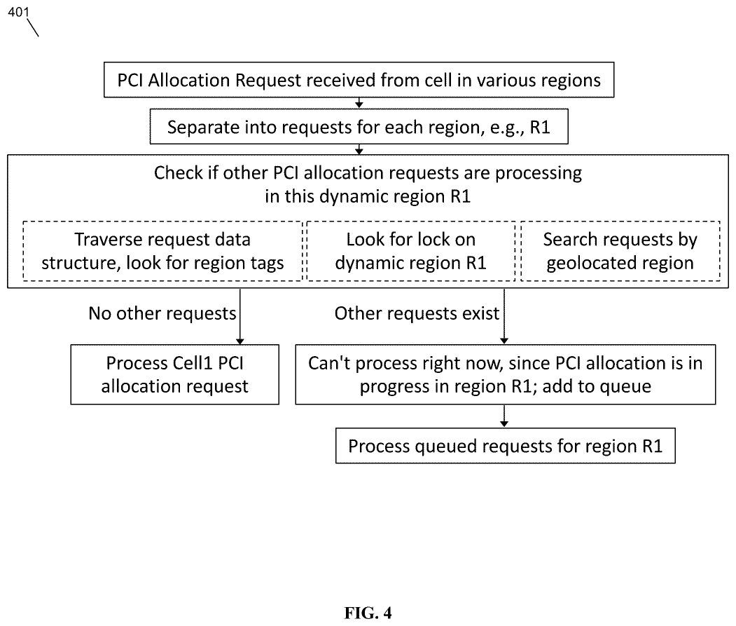

FIG. 4 is a further flowchart of messaging for PCI allocation in a cellular network, in accordance with some embodiments. FIG. 4 is meant to be a more general discussion of the flowchart shown in FIG. 3. In FIG. 4, when a given PCI allocation request is received from a cell, the request is optionally separated into requests for each region, and then a check is performed to check if other PCI allocation requests are processing in this dynamic region. The check may be by traversing a request data structure (like a queue) and looking for all matches for a given region, looking up the current region to see if that region is locked using a synchronization mechanism like a lock or a spinlock in a synchronization data structure, searching a (potentially larger) queue of requests by using the geographic location (e.g., lat/long together with a radius), etc. Other mechanisms for checking are understood to be possible as well. If there are no other requests in the region, then the request is processed; otherwise, the request is enqueued and later processed. The regions may be dynamic, e.g., the size of the regions may be determined at any time, including at runtime, and the size of the regions may be adjusted to improve performance or to reduce load.

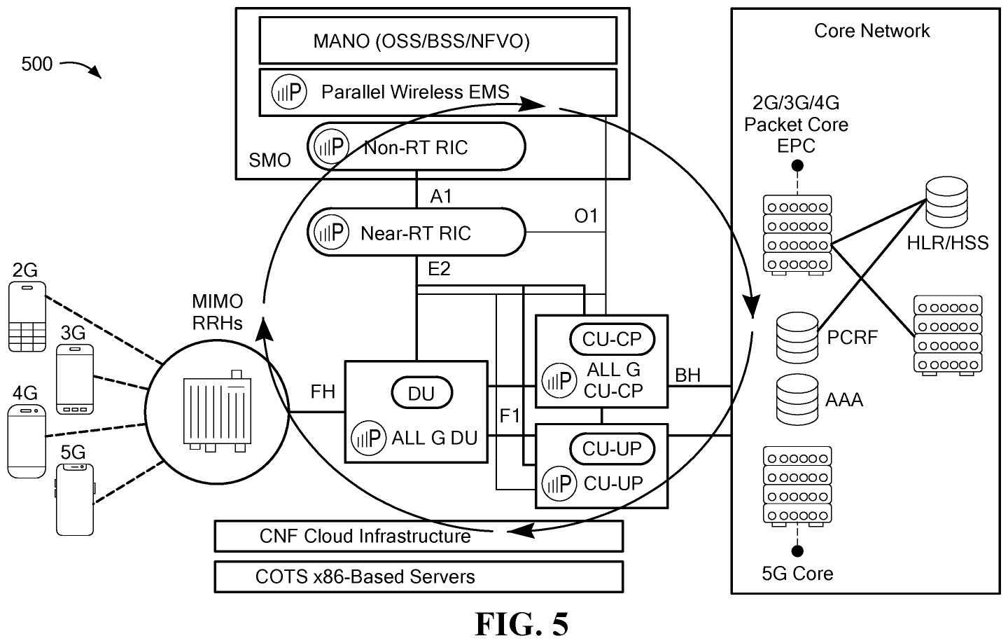

FIG. 5 is a schematic diagram of a multi-RAT RAN deployment architecture, in accordance with some embodiments. Multiple generations of UE are shown, connecting to RRHs that are coupled via fronthaul to an all-G Parallel Wireless DU. The all-G DU is capable of interoperating with an all-G CU-CP and an all-G CU-UP. Backhaul may connect to the operator core network, in some embodiments, which may include a 2G/3G/4G packet core, EPC, HLR/HSS, PCRF, AAA, etc., and/or a 5G core. In some embodiments an all-G near-RT RIC is coupled to the all-G DU and all-G CU-UP and all-G CU-CP. Unlike in the prior art, the near-RT RIC is capable of interoperating with not just 5G but also 2G/3G/4G. The MANO/EMS/non-RT RIC may perform the steps described herein as performed by the PCI allocation entity, in some embodiments.

The all-G near-RT RIC may perform processing and network adjustments that are appropriate given the RAT. For example, a 4G/5G near-RT RIC performs network adjustments that are intended to operate in the 100 ms latency window. However, for 2G or 3G, these windows may be extended. As well, the all-G near-RT RIC can perform configuration changes that takes into account different network conditions across multiple RATs. For example, if 4G is becoming crowded or if compute is becoming unavailable, admission control, load shedding, or UE RAT reselection may be performed to redirect 4G voice users to use 2G instead of 4G, thereby maintaining performance for users. As well, the non-RT RIC is also changed to be a near-RT RIC, such that the all-G non-RT RIC is capable of performing network adjustments and configuration changes for individual RATs or across RATs similar to the all-G near-RT RIC. In some embodiments, each RAT can be supported using processes, that may be deployed in threads, containers, virtual machines, etc., and that are dedicated to that specific RAT, and, multiple RATs may be supported by combining them on a single architecture or (physical or virtual) machine. In some embodiments, the interfaces between different RAT processes may be standardized such that different RATs can be coordinated with each other, which may involve interworking processes or which may involve supporting a subset of available commands for a RAT, in some embodiments.

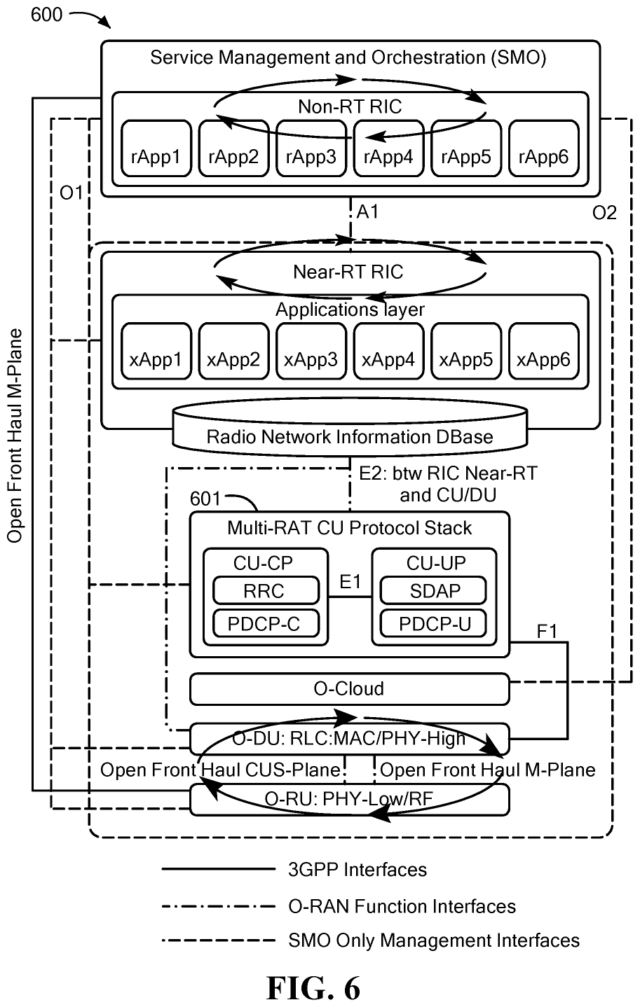

FIG. 6 is a further schematic diagram of a multi-RAT RAN deployment architecture, in accordance with some embodiments. The multi-RAT CU protocol stack 601 is configured as shown and enables a multi-RAT CU-CP and multi-RAT CU-UP, performing RRC, PDCP, and SDAP for all-G. As well, some portion of the base station (DU or CU) may be in the cloud or on COTS hardware (O-Cloud), as shown. Coordination with SMO and the all-G near-RT RIC and the all-G non-RT RIC may be performed using the A1 and O2 function interfaces, as shown and elsewhere as specified by the ORAN and 3GPP interfaces for 4G/5G.

In some embodiments, a microservice architecture may be used. [0012] In a cloud distributed architecture, pod & services life is transient. IP address of pods for internal communication are dynamically allocated at pod bring up. Number of pods vary based on load conditions in network. pods and service bring up sequence is dependent on of orchestrator and cloud resources. There is lot of dynamism in cloud deployments.

A product/service may be made up of multiple distinct microservices, pods and multiple interfaces to outside world. All the pods and micro services combined together provides some network function to outside world. It is desirable to identify set of pods and microservices available in given deployment dynamically.

Multiple services and worker pods stitched together to provide common function, may not be known to cloud providers. Load balancer microservices available today are very limited to few protocols only. Not all protocol are stateless, hence dynamic changes in internal environment are desired to be discovered and advertised in a matter of few milliseconds.

It is desirable to know if any changes like new Pod's creation and deletion or services added in our network function dynamically in matter of few milliseconds. Based on dynamic learning, our solution can adjust to new information and start making required changes in system seamlessly.

In the present disclosure, a pod is a group of one or more containers, which may have shared storage and network resources, and which may also have a specification for how to run the containers. A pod's contents may be co-located and co-scheduled, and run in a shared context. A pod may be an application-specific logical host, or may be non-application specific. In some embodiments, applications may be executed on different or the same physical or virtual machine. In some embodiments, applications may be cloud applications executed on the same logical host, or executed at a different location. Where pods and/or containers are described herein, various alternatives are also considered, such as Linux containers, Kubernetes containers, Microsoft Azure, or other cloud-based software technologies.

It is typical for multiple microservices and multiple types of pod combined together forming a single product deployment. Each inbound interface is handled by a microservice, for example, the E1 interface with CU-UP is handled by a E1-AP demux/microservice, and the NG interface with AMF+SMF is handled by an NGAP demux/microservice, and so on. Microservices being brought up and taken down in this way are able to handle demands flexibly and quickly, and react in a matter of milliseconds. The microservices shown are located inside the logical boundary of the pod.

Each pod may use an underlying physical CPU and memory, and access to these resources may be coordinated by a host OS layer, in some embodiments. Multiple pods may share the same physical CPU and/or memory.

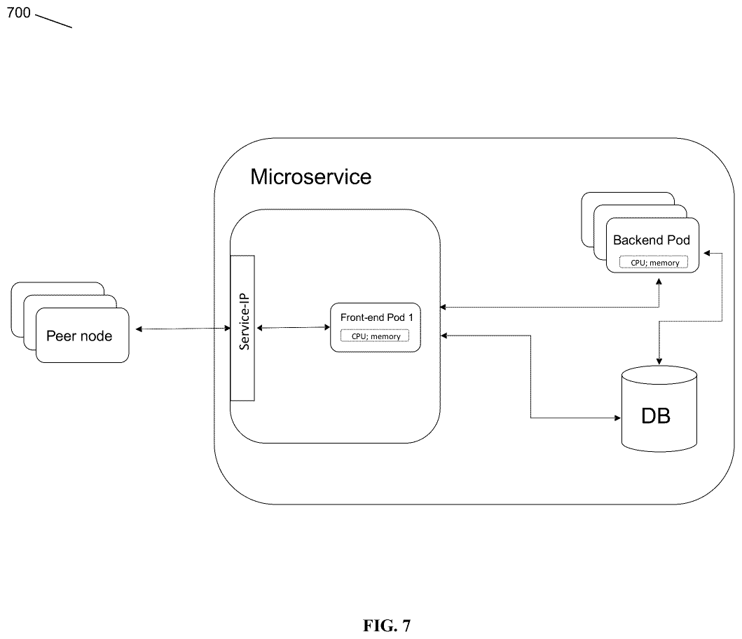

FIG. 7 is a schematic diagram showing a pod microservice internal discovery logical architecture, in accordance with some embodiments. Within a single microservice, the database hosts a service registry, while a controller performs service distribution. A front-end microservice pod serves to terminate the front end protocols and communicate with other microservices/pods, and a group of backend pods to service these microservices serves as a set of worker backend pods. Although multiple front-end pods are possible, the inventors have contemplated the benefit of providing high availability for a single front-end pod, for reasons as disclosed elsewhere herein.

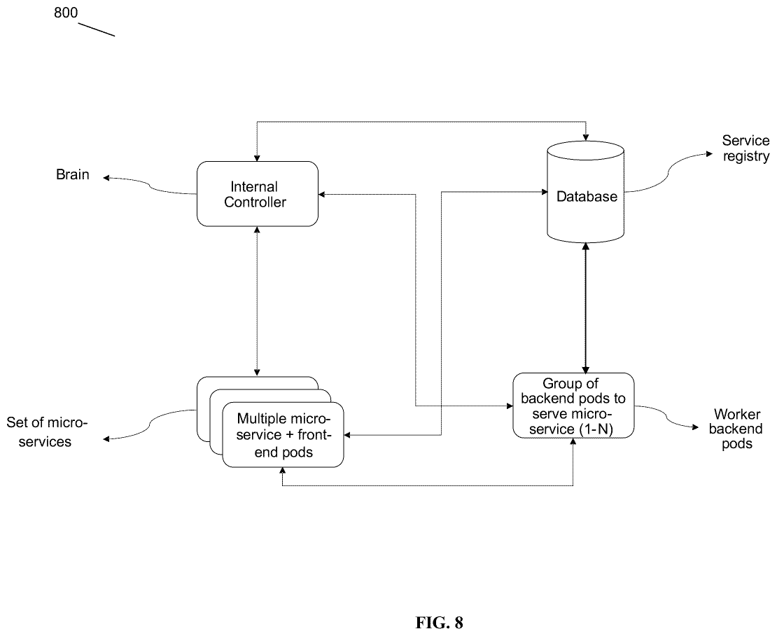

FIG. 8 is a schematic diagram showing a pod microservice logical architecture with front and back-end pods, in accordance with some embodiments. A plurality of front-end pods for terminating connections and back-end pods for handling and processing traffic is in communication with a database; the database handles registration of the pods as described below. Other nodes, such as peer nodes, interface with the microservice via a particular service IP, and routing is performed within the microservice to the front end pods and back end pods, in some embodiments by a routing pod.

### Additional Embodiments

In any of the scenarios described herein, where processing may be performed at the cell, the processing may also be performed in coordination with a cloud coordination server. A mesh node may be an eNodeB. An eNodeB may be in communication with the cloud coordination server via an X2 protocol connection, or another connection. The eNodeB may perform inter-cell coordination via the cloud communication server when other cells are in communication with the cloud coordination server. The eNodeB may communicate with the cloud coordination server to determine whether the UE has the ability to support a handover to Wi-Fi, e.g., in a heterogeneous network.

Although the methods above are described as separate embodiments, one of skill in the art would understand that it would be possible and desirable to combine several of the above methods into a single embodiment, or to combine disparate methods into a single embodiment. For example, all of the above methods could be combined. In the scenarios where multiple embodiments are described, the methods could be combined in sequential order, or in various orders as necessary.

Although the above systems and methods are described in reference to 3GPP, one of skill in the art would understand that these systems and methods could be adapted for use with other wireless standards or versions thereof.

In some embodiments, the software needed for implementing the methods and procedures described herein may be implemented in a high level procedural or an object-oriented language such as C, C++, C#, Python, Java, or Perl. The software may also be implemented in assembly language if desired. Packet processing implemented in a network device can include any processing determined by the context. For example, packet processing may involve high-level data link control (HDLC) framing, header compression, and/or encryption. In some embodiments, software that, when executed, causes a device to perform the methods described herein may be stored on a computer-readable medium such as read-only memory (ROM), programmable-read-only memory (PROM), electrically erasable programmable-read-only memory (EEPROM), flash memory, or a magnetic disk that is readable by a general or special purpose-processing unit to perform the processes described in this document. The processors can include any microprocessor (single or multiple core), system on chip (SoC), microcontroller, digital signal processor (DSP), graphics processing unit (GPU), or any other integrated circuit capable of processing instructions such as an x86 or ARM microprocessor.

In some embodiments, the radio transceivers described herein may be base stations compatible with a Long Term Evolution (LTE) radio transmission protocol or air interface. The LTE-compatible base stations may be eNodeBs. In addition to supporting the LTE protocol, the base stations may also support other air interfaces, such as UMTS/HSPA, CDMA/CDMA2000, GSM/EDGE, GPRS, EVDO, other 3G/2G, 5G, legacy TDD, or other air interfaces used for mobile telephony. 5G core networks that are standalone or non-standalone have been considered by the inventors as supported by the present disclosure.

In some embodiments, the base stations described herein may support Wi-Fi air interfaces, which may include one or more of IEEE 802.11a/b/g/n/ac/af/p/h. In some embodiments, the base stations described herein may support IEEE 802.16 (WiMAX), to LTE transmissions in unlicensed frequency bands (e.g., LTE-U, Licensed Access or LA-LTE), to LTE transmissions using dynamic spectrum access (DSA), to radio transceivers for ZigBee, Bluetooth, or other radio frequency protocols including 5G, or other air interfaces.

The foregoing discussion discloses and describes merely exemplary embodiments of the present invention. In some embodiments, software that, when executed, causes a device to perform the methods described herein may be stored on a computer-readable medium such as a computer memory storage device, a hard disk, a flash drive, an optical disc, or the like. As will be understood by those skilled in the art, the present invention may be embodied in other specific forms without departing from the spirit or essential characteristics thereof. For example, wireless network topology can also apply to wired networks, optical networks, and the like. The methods may apply to LTE-compatible networks, to UMTS-compatible networks, to 5G networks, or to networks for additional protocols that utilize radio frequency data transmission. Various components in the devices described herein may be added, removed, split across different devices, combined onto a single device, or substituted with those having the same or similar functionality. Where the term “all-G” is used herein, it is understood to mean multi-RAT (having at least two radio access technologies).

Although the present disclosure has been described and illustrated in the foregoing example embodiments, it is understood that the present disclosure has been made only by way of example, and that numerous changes in the details of implementation of the disclosure may be made without departing from the spirit and scope of the disclosure, which is limited only by the claims which follow. Various components in the devices described herein may be added, removed, or substituted with those having the same or similar functionality. Various steps as described in the figures and specification may be added or removed from the processes described herein, and the steps described may be performed in an alternative order, consistent with the spirit of the invention. Features of one embodiment may be used in another embodiment. Other embodiments are within the following claims.

1. A method, comprising:
receiving a PCI allocation request is received from a cell;
identifying a dynamic region for the received PCI allocation request;
performing a check to determine if other PCI allocation requests are processing in the dynamic region;
processing, if there are no other requests in the dynamic region, the received PCI allocation request;
enqueing, if there are other requests in the dynamic region, the received PCI allocation request.

2. The method of claim 1, wherein the check may be performed by: traversing a request data structure (like a queue) and looking for all matches for a given region; looking up the current region to see if that region is locked using a synchronization mechanism like a lock or a spinlock in a synchronization data structure; searching a queue of requests by using the geographic location.

3. The method of claim 1, wherein the dynamic region includes a lat/long and a radius.

4. The method of claim 1, wherein the regions may be made dynamic by adjusting the size of the regions at runtime based on configuration, to improve performance or to reduce load.

5. The method of claim 1, further comprising separating the request into requests for each region.

6. The method of claim 1, wherein the method is performed at a SON, EMS, or near-RT RIC.
